(19) United States
(12) Patent Application Publication
(10) Pub. No.: US 2016/0097493 A1
(43) Pub. Date: Apr. 7, 2016

(54) METHOD AND APPARATUS FOR A LIGHTING ASSEMBLY WITH AN INTEGRATED AUXILIARY ELECTRONIC COMPONENT PORT

(71) Applicants: Taylor W. Anderson, Mesa, AZ (US); Eric G. Lokken, Phoenix, AZ (US); Zach S. Luellen, San Tan Valley, AZ (US); Christopher P. Largent, Phoenix, AZ (US); Seth W. Anderson, Mesa, AZ (US); Stephen P. Adams, Mesa, AZ (US)

(72) Inventors: Taylor W. Anderson, Mesa, AZ (US); Eric G. Lokken, Phoenix, AZ (US); Zach S. Luellen, San Tan Valley, AZ (US); Christopher P. Largent, Phoenix, AZ (US); Seth W. Anderson, Mesa, AZ (US); Stephen P. Adams, Mesa, AZ (US)

(21) Appl. No.: 14/866,983

(22) Filed: Sep. 27, 2015

Related U.S. Application Data
(60) Provisional application No. 62/059,128, filed on Oct. 2, 2014.
(60) Provisional application No. 62/073,626, filed on Oct. 31, 2014.
(60) Provisional application No. 62/111,061, filed on Feb. 2, 2015.
(60) Provisional application No. 62/181,317, filed on Jun. 18, 2015.

(51) Int. Cl. F21K 99/00; F21S 8/10; G03B 15/03; F21V 33/00

(52) U.S. Cl. CPC F21K 9/50; F21V 33/0052; F21S 48/115; G03B 15/03; F21Y 2101/02

(57) ABSTRACT

A lighting fixture includes a plurality of light sources and an auxiliary component bay. The light sources and auxiliary component bay may be independently energized to cause one or more of the plurality of light fixtures to illuminate and/or to energize an auxiliary electronic component that is removably coupled to the auxiliary component bay. The auxiliary electronic component may include a camera, a battery pack, a work light or any other electronic device that may utilize operational power from a vehicle to perform a function. The auxiliary electronic component may include its own power converter which may accept a vehicular power signal to derive operation power therefrom. The lighting fixture may produce a beam pattern that is optimized for use when the auxiliary electronic component includes a camera. The auxiliary electronic component may be cooled by a thermoelectric device coupled to the component bay.

### FIELD OF THE INVENTION

The present invention generally relates to lighting systems, and more particularly to lighting systems with integrated auxiliary electronic components.

### BACKGROUND

Light emitting diodes (LEDs) have been utilized since about the 1960s. However, for the first few decades of use, the relatively low light output and narrow range of colored illumination limited the LED utilization role to specialized applications (e.g., indicator lamps). As light output improved, LED utilization within other lighting systems, such as within LED “EXIT” signs and LED traffic signals, began to increase. Over the last several years, the white light output capacity of LEDs has more than tripled, thereby allowing the LED to become the lighting solution of choice for a wide range of lighting solutions.

LEDs exhibit significantly optimized characteristics for use in lighting fixtures, such as source efficacy, optical control and extremely long operating life, which make them excellent choices for general lighting applications. LED efficiencies, for example, may provide for light output magnitudes that may exceed 100 lumens per watt of power dissipation. Energy savings may, therefore, be realized when utilizing LED-based lighting systems as compared to the energy usage of, for example, incandescent, halogen, compact fluorescent and mercury lamp lighting systems. As per an example, an LED-based lighting fixture may utilize a small percentage (e.g., 10-15%) of the power utilized by an incandescent bulb, but may still produce an equivalent magnitude of light.

LEDs may be mounted to a printed circuit board (PCB), which may include conductive regions (e.g., conductive pads) and associated control circuitry. The LED control terminals (e.g., the anode and cathode terminals of the LEDs) may be interconnected via the conductive pads, such that power supply and bias control signals may be applied to transition the LEDs between conductive and non-conductive states, thereby illuminating the LEDs on command.

Such LEDs may, for example, be utilized within light fixtures that are intended for use on vehicles (e.g., land-based, marine-based or airborne vehicles). Conventional light fixtures may not offer any other functionality other than to provide, for example, forward-projecting light from a plurality of LEDs.

Efforts continue, therefore, to develop uses for lighting fixtures that may extend beyond their use merely as forward-projecting light sources.

### SUMMARY

To overcome limitations in the prior art, and to overcome other limitations that will become apparent upon reading and understanding the present specification, various embodiments of the present invention disclose methods and apparatus for the placement of an auxiliary electronic component within a light fixture. The light fixture may, for example, include an integrated component bay that may allow for the temporary placement of the auxiliary electronic component within the light fixture. Accordingly, for example, the electronic component may draw upon the operational power supply of the light fixture (or a separate power supply dedicated to the auxiliary electronic component) to implement a variety of functionalities. As per one example, the auxiliary electronic component may simply draw upon an operational power supply to charge a battery contained within the auxiliary electronic component. As per another example, the auxiliary electronic component may draw upon an operational power supply to become operational while at the same time drawing enough power to charge a battery contained within the electronic component. The auxiliary electronic component may include a camera and the light fixture may include optics that generate a beam pattern that optimizes the functionality of the camera.

In accordance with one embodiment of the invention, a lighting system comprises a fixture, a plurality of light sources integrated within the fixture, one or more optics coupled to each of the plurality of light sources, a component bay integrated within the fixture and an auxiliary electronic component removably coupled to the component bay.

In accordance with another embodiment of the invention, a lighting system comprises a fixture, a plurality of light sources integrated within the fixture, one or more optics coupled to each of the plurality of light sources, a component bay integrated within the fixture and a camera removably coupled to the component bay. The one or more optics and plurality of light sources are configured to produce a beam pattern optimized for operation of the camera.

In accordance with another embodiment of the invention, a method of operating a lighting system that includes a fixture, a plurality of light sources, one or more optics, a component bay, and an auxiliary electronic component comprises coupling the auxiliary electronic component to the component bay, removably sealing the auxiliary electronic component within the component bay and activating the lighting system.

### BRIEF DESCRIPTION OF THE DRAWINGS

Various aspects and advantages of the invention will become apparent upon review of the following detailed description and upon reference to the drawings in which:

FIG. 1 illustrates an LED-based light fixture exhibiting an integrated component bay in accordance with one embodiment of the present invention;

FIG. 2 illustrates an exploded view of an LED-based light fixture exhibiting an integrated camera bay and an integrated camera port in accordance with one embodiment of the present invention;

FIG. 3 illustrates an exploded view of an LED-based light fixture exhibiting an integrated component bay and an integrated component port in accordance with one embodiment of the present invention;

FIG. 4 illustrates a block diagram in accordance with one embodiment of the present invention;

FIG. 5 illustrates a block diagram in accordance with an alternate embodiment of the present invention;

FIG. 6 illustrates a camera having a connector coupled to an internal power converter; and

FIG. 7 illustrates a block diagram in accordance with an alternate embodiment of the present invention.

### DETAILED DESCRIPTION

Generally, the various embodiments of the present invention are applied to a lighting system (e.g., a light emitting diode (LED) based lighting system) that may contain one or more light sources (e.g., LEDs) and one or more associated optical systems (e.g., reflective and refractive components). The light sources may be mounted to a PCB having power, control and bias circuitry that allows the light sources to be illuminated on command. A lens may be mounted forward of an associated light source, so as to control a pattern of light that may be projected by each light source of the lighting system.

In one embodiment, a lighting system may be attached to a vehicle (e.g., a land-based, marine-based or airborne vehicle) and configured to operate from a power supply (e.g., the battery, alternator and associated regulation circuitry of the vehicle). The lighting system may include an integrated component bay that may be configured to accept a variety of auxiliary electronic components and may be further configured with an input/output (I/O) port that may provide, among other things, operational power to the auxiliary electronic component during one or more modes of operation.

In a first mode of operation, the lighting system may be operational while depriving the I/O port integrated within the integrated component bay from access to the operational power. In a second mode of operation, the lighting system may be deprived of operational power while the I/O port is provided access to the operational power. In a third mode of operation, the lighting system and I/O port may have independent access to operational power and may become operational independently of one another. In a fourth mode of operation, the lighting system and I/O port may have simultaneous access to operational power and each may become operational simultaneously with one another.

The component bay of the lighting system may be configured to accept an auxiliary electronic component that may require operational power to become functional. As an example, such an auxiliary electronic component may include its own source of power (e.g., a battery), but may derive operational power from the lighting system (or a power supply that is shared with the lighting system) via the I/O port in order to maintain and/or increase an amount of energy stored within the battery once the auxiliary electronic component is inserted into the component bay. As per another example, the auxiliary electronic component may not include its own source of power and, therefore, may not become operational until the electronic component is inserted into the component bay.

Accordingly, the auxiliary electronic component may represent any number of types of electronic components that may require operational power for operation. In one embodiment, the auxiliary electronic component may include a camera having an integrated battery, such that when the camera is inserted into the component bay, the battery may become fully charged and available for use during the charging cycle and/or after the charging cycle has completed. Conversely, the camera may or may not include a battery and may become operational the instant the camera is inserted into the component bay. In another embodiment, the auxiliary electronic component may include a work light having an integrated battery, such that when the work light is inserted into the component bay, the battery may become at least partially charged and available for use once the charging cycle is adequately completed. As another example, the electronic component may itself be a battery that when inserted into the component bay, may become charged and available for use in other electronic equipment (e.g., a battery-operated drill, circular saw, air compressor or flashlight).

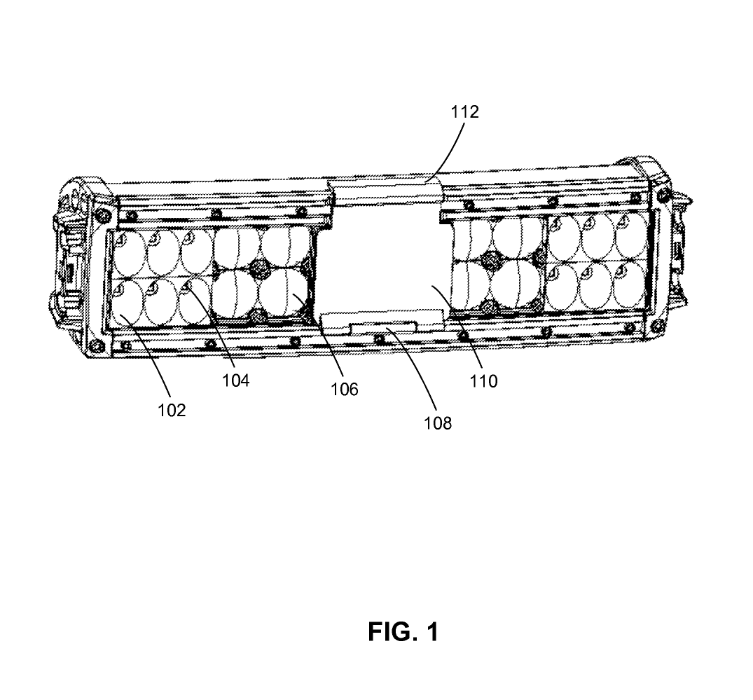

Turning to FIG. 1, LED-based light fixture 100 is exemplified. Light fixture 100 may, for example, include one or more light sources (e.g., LEDs 104) and associated optics (e.g., reflector 102 and/or lens 106) as may be required for a particular application. Light fixture 100 may, for example, be adapted for use on any type of vehicle (e.g., land-based, water-based or aeronautical vehicles). As per one example, one or more light fixtures 100 may be adapted for use on off-road vehicles and used to project light forward of the off-road vehicle so as to better illuminate the vehicle's path at night or during other conditions that might otherwise limit visibility (e.g., during overcast conditions).

Light fixture 100 may also include an auxiliary component bay (not shown) which may be enclosed via hatch 110. Hatch 110 may, for example, rotate about an axis, as may be defined by hinge 108, so as to allow egress and ingress of auxiliary electronic components (not shown) that may be housed within the auxiliary component bay (not shown). Hatch 110 may, for example, include latching mechanism 112 that may fix hatch 110 in place. In one embodiment, hatch 110 may provide mechanical retention to maintain a position of the auxiliary electronic components (not shown) that may be housed within the auxiliary component bay (not shown). In addition, hatch 110 may include a sealing mechanism (e.g., a rubber gasket) that may seal a perimeter of the component bay, thereby protecting the auxiliary electronic component (not shown) that may be housed within the auxiliary component bay (not shown) from contaminants (e.g., rain, atmospheric particulates, etc.).

Hatch 110 may, for example, be transparent so as to allow viewing of the auxiliary electronic component while hatch 110 is closed. Accordingly, for example, an indication (e.g., an illuminated indicator light) that may signal that the auxiliary electronic component contained within the component bay has attained full charge may be readily seen even when hatch 110 is closed. In addition, any auxiliary electronic component (e.g., a camera) requiring access to a forward view from within lighting fixture 100 may be facilitated by a transparent hatch 110 in closed position.

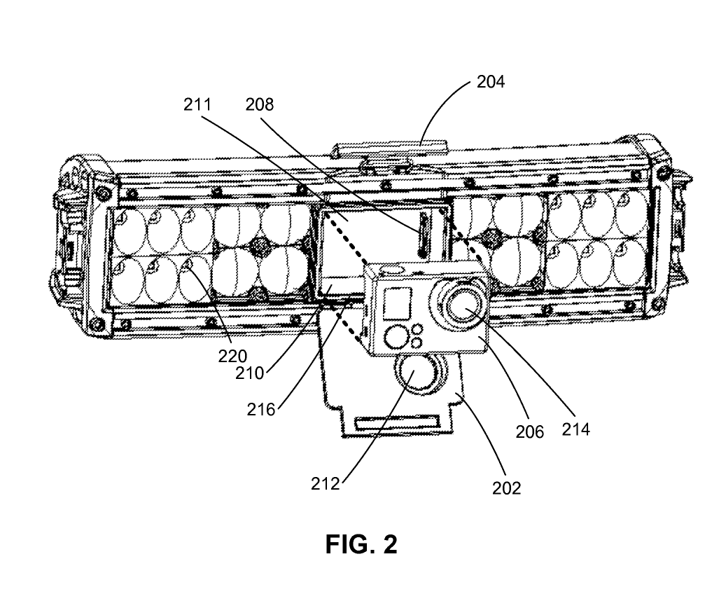

Turning to FIG. 2, light fixture 200 is exemplified in exploded view to further illustrate component bay 210 and an auxiliary electronic component (e.g., camera 206) that may be housed within component bay 210. Hatch 202 is illustrated in an open position to, for example, allow egress/ingress of camera 206 from/to component bay 210.

Hatch 202 may, for example, be contoured to facilitate placement of auxiliary electronic components within component bay 210. As an example, auxiliary electronic component (e.g., camera 206) may include a protrusion (e.g., lens 214) that would otherwise preclude closure of hatch 202 if not for contour 212. Further, a mechanical device (e.g., a rubber gasket not shown) may exist between a perimeter of lens 214 and a corresponding perimeter of contour 212 such that once hatch 202 is closed, a mechanical friction may exist between hatch 202 and camera 206 to substantially prevent movement of camera 206 within component bay 210. Still further, a mechanical device (e.g., rubber gasket 216) may exist between a perimeter of component bay 210 and a corresponding perimeter of hatch 202 such that once hatch 202 is closed, a mechanical seal may exist between hatch 202 and component bay 210 to maintain component bay 210 substantially free of contaminants.

Component bay 210 may, for example, include I/O port 208, which may provide I/O signals (e.g., an operational power signal) to an auxiliary electronic component (e.g., camera 206). Camera 206 may, for example, include a mating connector that may be compatible with I/O port 208. As such, once camera 202 is secured within component bay 210, I/O port 208 may be in electrical and/or mechanical communication with camera 206, which may provide additional mechanical stability to camera 206.

I/O port 208 may, for example, be in electrical communication with a power source from which an operational power signal may be derived. Such a power source may be common to the power source required by light fixture 200, such as may be the case when light fixture 200 is mounted to a vehicle that may include its own power source (e.g., battery, alternator and regulator). Accordingly, for example, camera 202 may have access to a source of operational power that under normal circumstances won't be depleted.

In such an instance, camera 206 may be free to operate for a duration of time that otherwise would not be possible. As an example, camera 206 may be configured with operational memory that may provide a maximum number of hours (e.g., 6 hours) of video to be captured. Camera 206 may, however, only be operational for a limited duration (e.g., 1.5 hours) due to a deficient battery capacity. In such an instance, camera 206 may only have enough operational power to populate a fraction (e.g., one quarter) of its video memory. However, once camera 206 is connected to I/O port 208, camera 208 may derive its operational power from the associated vehicle's power source such that any duration of operation (e.g., several hours to several days to several weeks) may be accommodated. Alternately, component bay 210 may simply function as a charging bay for camera 206, such that once camera 206 is connected to I/O 208 and allowed to fully charge, camera 206 may then be removed from component bay 210 and utilized in another capacity outside of its use within component bay 210.

Light fixture 200 may further include one or more LED light sources 220 and associated optics (e.g., reflector 102 of FIG. 1, lens 106 of FIG. 1, or both). The one or more LEDs 220 and associated optics may be configured to optimize light emitted by the light fixture 200. In one example, light emitted by light fixture 200 may be designed for camera 206 such that camera 206 may be optimized for operation due to the beam pattern emitted by light fixture 200. For example, light emitted by light fixture 200 may optimize image capture or video recording of camera 206. In another example, the LEDs 220 and associated optics may be selected to produce a uniform beam pattern. In another example, the LEDs 220 and associated optics may be selected to produce a smooth beam pattern. In another example, the LEDs 220 and associated optics may be selected to substantially eliminate hot spots in the beam pattern, where hot spots may be defined to be areas of significantly higher light intensity that may be surrounded by areas of lower light intensity.

Light fixture 200 may have a curvature along a length thereof. The curvature may be slight or pronounced, such that the optical axis of a particular LED 220 is non-parallel to an optical axis of each of its neighboring LEDs 220. A more pronounced curvature may, for example, provide an increased angle of separation between the optical axis of a particular LED 220 and the optical axes of its neighboring LEDs. A less pronounced curvature may, for example, provide a decreased angle of separation between the optical axis of a particular LED 220 with respect to the optical axes of its neighboring LEDs. The curvature may optimize light emission from light fixture 200. In one example, the curvature may cause a widening of the beam width emitted by light fixture 200 (e.g., to produce a more pronounced flood beam pattern). In another example, the curvature may cause a narrowing of the light emitted by light fixture 200 (e.g., to produce a less pronounced flood beam pattern).

Component bay 210 of light fixture 200 may be formed of one or more sides (e.g., back, right, left, top and bottom sides). The sides may be sized and shaped to accommodate camera 206. Further, the sides may be sized and shaped to prevent camera 206 from experiencing rattling or vibrations within component bay 210.

A thermoelectric device 211 may be coupled to one or more sides of component bay 210 (e.g., to the back side). Thermoelectric device 211 may exhibit a surface area that may be less than or equal to a surface area of one of the one or more sides of component bay 210 (e.g., an area equal to the back side). Thermoelectric device 211 may be located on an interior of component bay 210, on an exterior of component bay 210, or may extend through a side of component bay 210.

Thermoelectric device 211 may be electrically coupled to the power system of the light fixture 200 and may be capable of inducing heat transfer as a result of a current passing therethrough. Furthermore, the direction of heat transfer (e.g., reducing heat or increasing heat) may be selected by the selected direction of current flow through thermoelectric device 211. For example, when activated, thermoelectric device 211 may cause heat to be passed from the interior of component bay 210 to the exterior of component bay 210 using a first direction of current flow. Conversely, for example, thermoelectric device 211 may cause heat to be passed from the exterior of component bay 210 to the interior of component bay 210 using a second direction of current flow. Thus, thermoelectric device 211 may prevent camera 206 from overheating and/or freezing while being held within component bay 210.

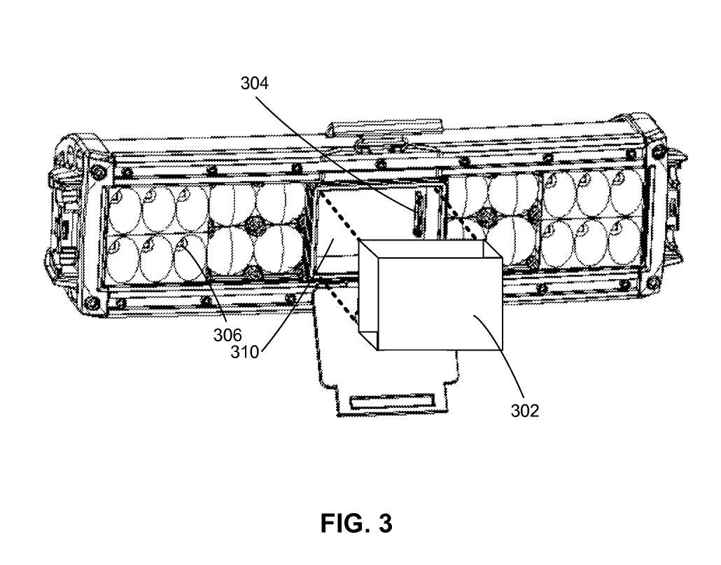

Turning to FIG. 3, an alternate embodiment is exemplified, whereby auxiliary electronic component 302 may include any number of electronic components, such as a work light, a battery pack, or any other type of portable electronic component that may be battery operated or otherwise require a direct current (DC) power source for charging/operation. As an example, auxiliary electronic component 302 may include a work light having a charging connector compatible with I/O port 304 and that resides within component bay 310 while electrically connected to I/O port 304. Work light 302 may then derive operational power from I/O port 304 to maintain the battery (not shown) within work light 302 at maximum charge. In such an instance, for example, light fixture 300 may be adapted for use with a land-based vehicle and work light 302 may be fully charged at all times and available for use during times of need (e.g., when the associated vehicle is broken down and pulled off onto the side of the road).

Auxiliary electronic component 302 may, for example, include a direct current to alternating current (DC-AC) converter. As such, for example, auxiliary electronic component 302 may derive operational power from the associated vehicle's power supply and convert the related voltage from a DC voltage to an AC voltage (e.g., 110 volts at 60 Hz having a sinusoidal shape). In so doing, for example, any appliance requiring an AC voltage for operation (e.g., a television or blender) may be operated by first connecting auxiliary electronic component 302 to I/O port 304 and then connecting the appliance to auxiliary electronic component 302.

I/O port 304 may, for example, exchange other signals beyond those required as operational power signals. For example, referring back to FIG. 2, camera 206 may provide real-time audio/video footage in one or more formats (e.g., RGB, HDMI or composite) to a monitor that may exist in the cabin area of the associated vehicle via I/O port 208. In such an instance, for example, the video footage may be transmitted to the monitor to be viewed within the cabin of the vehicle in real time and/or to a recording device within the cabin. Alternately, for example, the video footage may be provided to a transmission device (e.g., an RF transmission device) within the associated vehicle and then forwarded on to a security monitoring station, which may then be monitored by the security monitoring station for added security when the vehicle is left unattended. In such an instance, a latch mechanism (e.g., latch mechanism 204 of FIG. 2) may be secured against unauthorized access (e.g., may require keyed access for actuation).

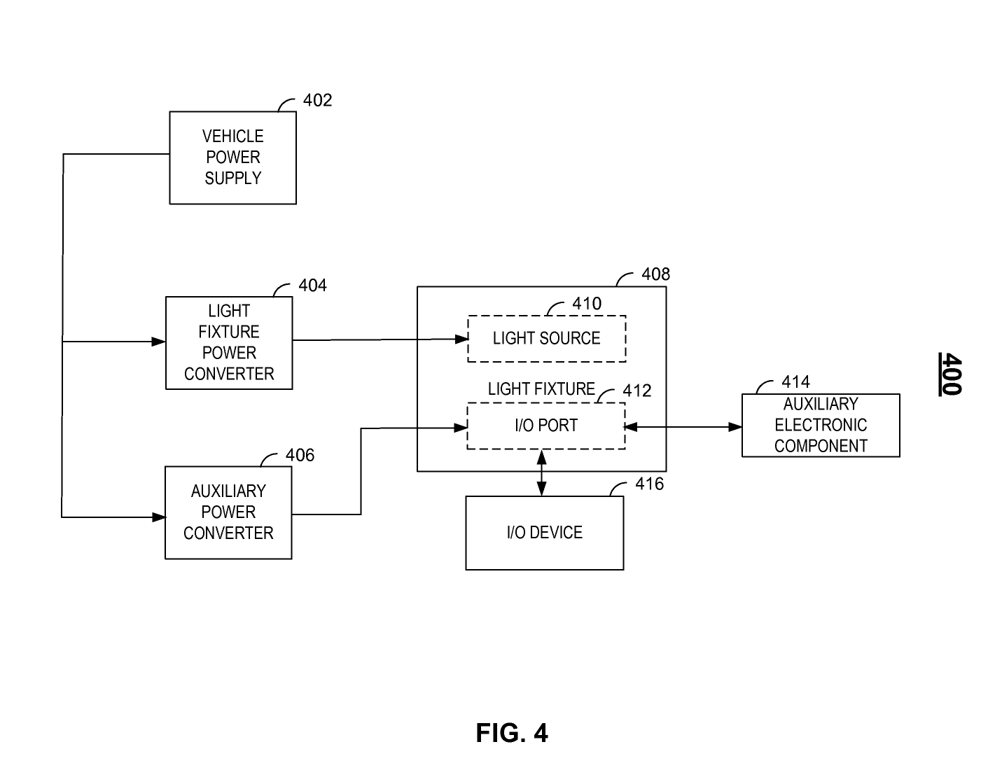

Turning to FIG. 4, a block diagram is exemplified, which may include vehicle power supply 402, which may include a battery, an alternator and a regulator, among other components. Vehicle power supply 402 may, for example, generate an operating voltage (e.g., 12 VDC) that is compatible with the associated vehicle and that may be used by light fixture power converter 404 and auxiliary power converter 406. Light fixture power converter 404 and auxiliary power converter 406 may, for example, include power converters (e.g., buck, boost, buck-boost or flyback converters), which may accept a wide range of input voltage magnitude (e.g., 9 VDC to 36 VDC) and may, in response, provide an output voltage that may be compatible with light source 410 and I/O port 412, respectively, of light fixture 408.

Light fixture 408 may, for example, represent either of light fixtures 100, 200 or 300 of FIGS. 1-3, respectively. Light source 410 may, for example, represent the light sources of the respective light fixtures (e.g., LED light sources 104 of FIG. 1, LED light sources 220 of FIG. 2, or LED light sources 306 of FIG. 3). I/O port 412 may, for example, represent I/O port 208 of FIG. 2 or I/O port 304 of FIG. 3. Auxiliary electronic component 414 may, for example, represent camera 206 of FIG. 2 or any multitude of auxiliary electronic components as may be represented by component 302 of FIG. 3. I/O device 416 may, for example, be any device that may receive data as provided by auxiliary electronic component 414.

Operable power from vehicle power supply 402 may be provided as switched power to light fixture power converter 404 and/or auxiliary power converter 406, either in conjunction with an ignition signal provided from the vehicle's ignition system or as provided by user input via a switch. Accordingly, for example, light fixture power converter 404 and auxiliary power converter 406 may be independently operated when the vehicle's ignition system is in operation or when the user has bypassed the vehicle's ignition system and has selected operation when the vehicle is not in operation.

Accordingly, for example, both light source 410 and auxiliary electronic component 414 (via I/O port 412) may be independently operated whether or not the vehicle's ignition system is active. Timers (not shown) may, for example, be used to render light fixture power converter 404 and auxiliary power converter 406 inactive after a period of time that light source 410 and/or auxiliary electronic component 414 is detected to be inoperable. Conversely, once the energy level of vehicle power supply 402 drops below a threshold level, light fixture power converter 404 and auxiliary power converter 406 may then be rendered inoperable.

It should be noted that light fixture power converter 404 and/or auxiliary power converter 406 may exist within light fixture 408, or conversely, may exist external to light fixture 408. In addition, auxiliary power converter 406 may be omitted, thereby allowing light fixture power converter 404 to supply operational power to both light source 410 and I/O port 412 as needed.

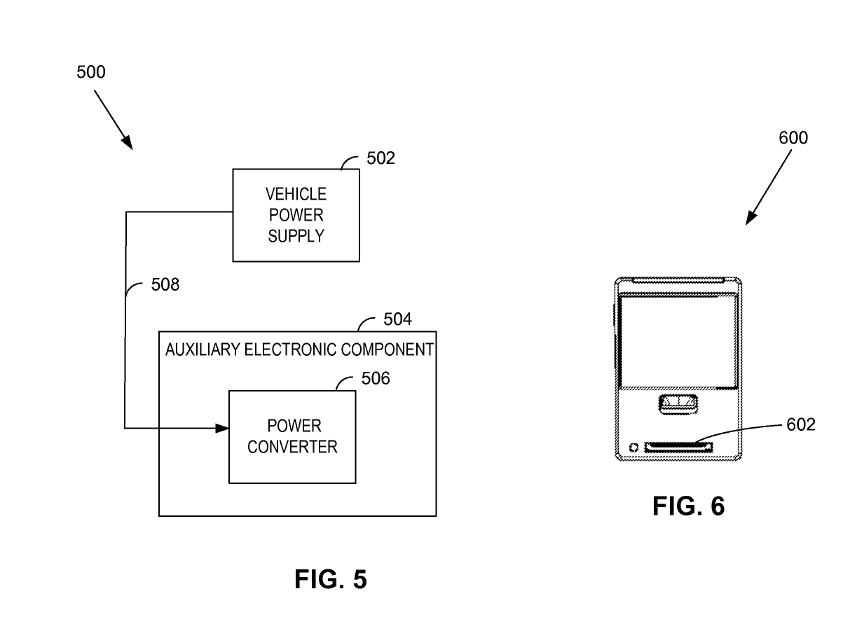

In an alternate embodiment, as illustrated in FIGS. 5 and 6, auxiliary electronic component 504 (e.g., camera 600) may include an internal power converter 506 (e.g., a buck, boost, buck-boost or flyback converter), which may accept a wide range of input voltage magnitude (e.g., 9 VDC to 36 VDC or 110 VAC to 220 VAC) as may be generated by vehicle power supply 502 and may, in response, provide an output voltage that may be compatible with auxiliary electronic component 504.

Power connection 508 may include any power connection readily available within a vehicle (e.g., cigarette lighter, auxiliary 12V DC power outlet, universal serial bus (USB) connection or auxiliary AC outlet). Power converter 506 may, for example, detect the presence of an input power signal (e.g., a DC or AC input power signal) and perform a requisite operation (e.g., rectification and/or DC-DC conversion) so as to produce operational power that is compatible with the internal electronics (not shown) of auxiliary electronic component 504 (e.g., camera 600).

Power connection 508 may, for example, provide the appropriate mechanical adaptation that may be necessary to connect vehicle power supply 502 to power converter 506. For example, power connection 508 may include an adaptor (e.g., a USB adaptor) that may allow connection from within an interior of the vehicle (e.g., a USB connection within the vehicle) to an auxiliary electronic component (e.g., connector 602 of camera 600). In an alternate embodiment, connector 602 may itself be compatible with a connection (e.g., a USB connection) from within an interior of the vehicle.

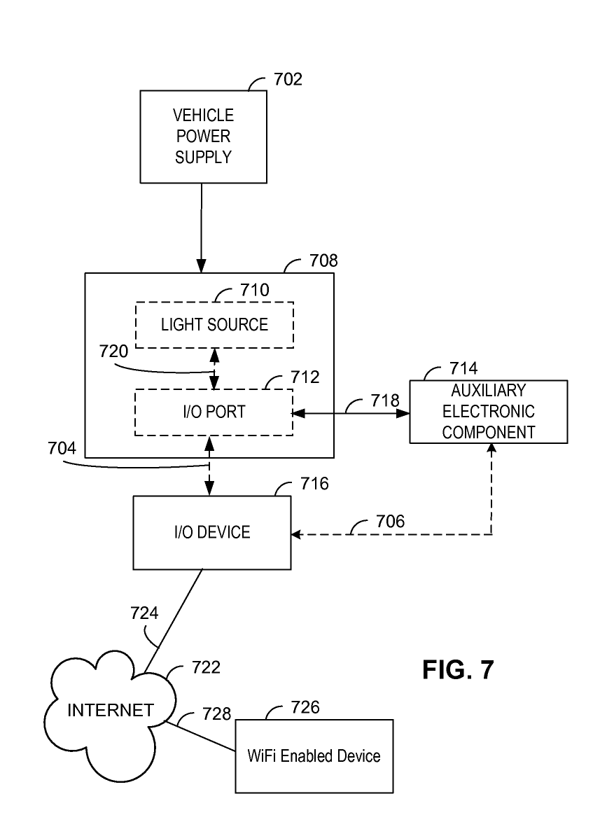

Turning to FIG. 7, an alternate embodiment is illustrated, which may include vehicle power supply 702, light fixture 708 that may include a light source 710, an auxiliary electronic component (e.g., camera 714) that may or may not be included within light fixture 708 and an I/O device 716. I/O device 716 may, for example, communicate with camera 714 via I/O Port 712 via communication channel 704 and/or auxiliary communication channel 706.

In one embodiment, I/O device 716 may include a memory management device (e.g., a microSD card) that may either be co-located with camera 714 (e.g., plugged into the microSD port of camera 714) or remotely located with respect to camera 714. If remotely located, I/O device 716 may, for example, include a microSD storage hub, within which one or more microSD cards may be inserted and may receive audio/video feeds from camera 714 for storage. Hot swapping capabilities may also exist, such that camera 714 may be directed to store audio/video information to one microSD card within I/O device 716 while another microSD card, previously filled with information, is replaced with a fresh microSD card. In so doing, continuous recording may be accomplished without interruption, such that while vehicle power supply 702 may provide continuous power to camera 714, I/O device 716 may provide continuous memory storage to facilitate unlimited recording capability.

In an alternate embodiment, I/O device 716 may include a USB storage hub, whereby USB interface 706 may be used to extract information from camera 714 without removing camera 714 from I/O port 712. Accordingly, for example, camera 714 may be left inside an associated component bay (e.g., component bay 210 of FIG. 2) while USB interface 706 is used to extract information (e.g., information stored internally within camera 714 or information stored within a microSD card that is inserted into a microSD port of camera 714) from camera 714.

In an alternate embodiment, I/O device 716 may include audio/video extraction capabilities, such that audio and/or video feeds provided to camera 714 (e.g., via interface 718) may also be routed to I/O device 716 (e.g., via interfaces 704 and/or 706 that may be wired or wireless). For example, audio information transmitted to camera 714 may be routed to I/O device 716 to be processed by equipment (e.g., microphones) that may have a higher fidelity as compared to the audio recording device contained within camera 714. Alternately, for example, marking (e.g., audio marking) capabilities may be utilized to annotate the audio and/or video feeds with telemetry information, GPS information or any other type of information that may help to identify and time stamp the audio and/or video feed. As an example, line inputs from other audio feeds (e.g., pit and cockpit communications) may be overlaid onto the audio/video feeds provided to camera 714 (e.g., via interface 718) so that during replay, for example, a race crew may review footage captured by camera 714 during a race, while at the same time monitoring pit/cockpit communications overlaid onto the camera footage that occurred in real time during the race.

In an alternate embodiment, I/O device 716 may communicate with camera 714 (e.g., via interface 704 and/or 706), which may include wired and/or wireless communication capabilities. In such an instance, I/O device 716 may include remote control capability of camera 714, such that certain status and control functions (e.g., on/off, record/stop, zoom, shutter speed, f-stop and audio/video marking capability) may be remotely controlled by an operator without having physical access to camera 714 (e.g., while camera 714 is installed within component bay 214 of FIG. 2 and the operator is driving the car within which light fixture 708 is installed). As an example, an operator may utilize I/O device 716 to annotate the recording with one or more markers to allow fast-forward capability to such markers during playback.

In an alternate embodiment, I/O device 716 may provide the operator with exposure and white balance information that may be generated by camera 714. In such an instance, video quality may be optimized by the operator via I/O device 716 by allowing the operator to monitor video quality information from camera 714 while at the same time allowing the operator to facilitate light output intensity from light source 710. For example, I/O device 716 may allow the operator to control light output intensity of light source 710 while monitoring video quality information from camera 714, so as to minimize reflections and other spurious video information from washing out the recorded video.

In an alternate embodiment, I/O device 716 may provide wired or wireless (e.g., Wi-Fi) connectivity to internet 722 via interface 724. In so doing, for example, operators may share their experiences by uploading their audio and/or video files recorded by camera 714 into their respective social media applications (e.g., Facebook, Instagram, Twitter, etc.). In addition, with GPS tracking, operators' progress may be tracked by other interested viewers using an internet-based tracking utility (e.g., Google Earth).

In an alternate embodiment, I/O device 716 may provide accelerometer and gyro information to help stabilize camera 714 to filter vehicle motion and vibration information from contaminating the video feed as recorded by camera 714. In addition, I/O device 716 may, for example, provide a remote control interface to allow the operator to control the position of light fixture 708 (and hence the relative position of camera 714) as needed (e.g., to control the angle of light fixture 708 to compensate for angle variations caused by terrain).

In an alternate embodiment, I/O device 716 may provide an interface to an application (e.g., a Wi-Fi application) that may be executing within internet 722. Accordingly, for example, an operator may utilize his or her Wi-Fi enabled device (e.g., smartphone, laptop or tablet 726) to access I/O device 716 via the Wi-Fi application running on internet 722 to control any and all aspects of light fixture 708 and/or auxiliary electronic component (e.g., camera 714) and to obtain status information as well. In so doing, for example, the operator may issue command and control instructions via device 726, communication channels 724, 728 and internet 722 to light fixture 708 and/or auxiliary electronic component (e.g., camera 714). In response, I/O device 716 may carry out those command and control instructions via interfaces 704 and/or 706 as necessary.

As an example, light source 710 may include infrared (IR) light emitting diodes (LEDs) as well as other LEDs that operate at other wavelengths and each LED type may be individually activated via the Wi-Fi application of device 726. Device 726 may be used to activate such IR LEDs within light fixture 708. The imager within camera 714 may, for example, likewise be optimized for operation with IR via the command and control interface so that camera 714 may be operated as a night vision camera. Such night vision images may be subsequently uploaded to device 726 and/or to a monitor within the vehicle. Accordingly, for example, the vehicle, through operation of its night-vision camera, may be navigated at night or other conditions.

Other aspects and embodiments of the present invention will be apparent to those skilled in the art from consideration of the specification and practice of the invention disclosed herein. It is intended, therefore, that the specification and illustrated embodiments be considered as examples only, with a true scope and spirit of the invention being indicated by the following claims.

What is claimed is:

1. A lighting system, comprising:
a fixture;
a plurality of light sources integrated within the fixture;
one or more optics coupled to each of the plurality of light sources;
a component bay integrated within the fixture; and
an auxiliary electronic component removably coupled to the component bay.

2. The lighting system of claim 1, wherein the auxiliary electronic component is one of a camera, a work light, a flashlight and a battery.

3. The lighting system of claim 1, wherein the plurality of light sources includes one of LEDs and infrared LEDs.

4. The lighting system of claim 1, wherein the light fixture includes a hatch, the hatch configured to enclose the component bay and retain the auxiliary electronic component within the component bay.

5. The lighting system of claim 4, wherein the hatch includes a sealing mechanism capable of sealing an interior of the component bay from an exterior of the component bay.

6. The lighting system of claim 4, wherein the hatch includes a latch mechanism capable of retaining the hatch in a closed position.

7. A lighting system, comprising:
a fixture;
a plurality of light sources integrated within the fixture;
one or more optics coupled to each of the plurality of light sources;
a component bay integrated within the fixture; and
a camera removably coupled to the component bay, wherein the one or more optics and plurality of light sources are configured to produce a beam pattern optimized for operation of the camera.

8. The lighting system of claim 7, wherein the component bay includes a first input/output port and the camera includes a second input/output port, the first and second input/output ports coupled to each other when the camera is coupled to the component bay.

9. The lighting system of claim 7, wherein optimizing the beam pattern includes generating a beam pattern substantially void of hot spots.

10. The lighting system of claim 7, wherein optimizing the beam pattern includes generating a substantially uniform beam pattern.

11. The lighting system of claim 7, wherein optimizing the beam pattern includes generating a substantially smooth beam pattern.

12. The lighting system of claim 7, wherein the fixture is curved to align an optical axis of each of the plurality of light sources along non-parallel paths.

13. A method of operating a lighting system including a fixture, a plurality of light sources, one or more optics, a component bay, and an auxiliary electronic component, the method comprising:
coupling the auxiliary electronic component to the component bay;
removably sealing the auxiliary electronic component within the component bay; and
activating the lighting system.

14. The method of claim 13, wherein activating the lighting system includes activating only the plurality of light sources.

15. The method of claim 13, wherein activating the lighting system includes activating only the auxiliary electronic component.

16. The method of claim 13, wherein activating the lighting system includes activating the plurality of light sources and the auxiliary electronic component simultaneously.

17. The method of claim 16, further comprising adjusting an intensity of light output from the plurality of light sources to optimize operation of the auxiliary electronic component.

18. The method of claim 13, further comprising installing the lighting system on a vehicle.

19. The method of claim 18, wherein activating the lighting system includes providing operational power to the lighting system after an ignition of the vehicle is activated.

20. The method of claim 13, wherein activating the lighting system includes providing operational power upon a user's input via a switch.

21. The method of claim 13, wherein activating the lighting system includes passing data from the auxiliary electronic component via a transmission device to a monitoring station external to the fixture.

22. The method of claim 21, wherein the data is passed wirelessly.

23. The method of claim 21, wherein the auxiliary electronic component is controlled wirelessly.
